(19) United States
(12) Patent Application Publication
(10) Pub. No.: US 2025/0334391 A1
(43) Pub. Date: Oct. 30, 2025

(54) EXPANSION/CONTRACTION CARBON VEIL CONSTANTAN SENSOR

(71) Applicant: SM Electronics, Jeonju-si (KR)

(72) Inventor: Jun Ho JEONG, Jeonju-si (KR)

(73) Assignee: SM Electronics, Jeonju-si (KR)

(21) Appl. No.: 18/804,324

(22) Filed: Aug. 14, 2024

(30) Foreign Application Priority Data
Apr. 29, 2024 (KR) 10-2024-0056719

(51) Int. Cl. G01B 7/16; G01B 1/00

(52) U.S. Cl. CPC G01B 7/18; G01B 1/00

(57) ABSTRACT

According to the present disclosure, a thin film constantan sensing layer made of constantan which maintains electrical resistivity in a constant temperature range and has good fatigue life and thus maintains stable performance for a long time, and a carbon veil sensing layer with good tensile strength and tensile elastic modulus measure electrical resistance variations, thereby detecting expansion/contraction.

### CROSS-REFERENCE TO RELATED APPLICATIONS

This application claims the priority of Korean Patent Application No. 10-2024-0056719 filed on Apr. 29, 2024, in the Korean Intellectual Property Office, the disclosure of which is incorporated herein by reference.

### BACKGROUND

### Field

The present disclosure relates to an expansion/contraction carbon veil constantan sensor.

### Description of the Related Art

Hydrogen is a clean energy source, and its demand is gradually increasing. However, since hydrogen has high explosive properties, safe storage and transportation of hydrogen are important.

Various types of hydrogen tanks and hydrogen pipes are used to store and transport hydrogen. Since hydrogen is sensitive to changes in temperature and pressure, even small changes in temperature and pressure cause hydrogen to expand or contract, increasing or decreasing the internal pressure of the hydrogen tank or hydrogen pipe, and the increase or decrease in pressure causes the hydrogen tank or the hydrogen pipe to expand or contract frequently.

Therefore, when the hydrogen tank or the hydrogen pipe repeatedly expands or contracts in this way, damage, leakage, and explosion accidents may occur. The development of a sensor that may precisely detect the degree of expansion or contraction of the hydrogen tank or the hydrogen pipe without being affected by the change in temperature to prepare for the damage, leakage, and explosion accidents is required.

### SUMMARY

An object to be achieved by the present disclosure is to provide an expansion/contraction carbon veil constantan sensor capable of solving the above-described problems.

To achieve the above object, according to an aspect of the present disclosure, there is provided an expansion/contraction carbon veil constantan sensor, including:
a flexible and insulating PI substrate layer;
a thin film constantan sensing layer that is coupled to an upper surface of the PI substrate layer and has an electrical resistance changing due to expansion/contraction;
a cover layer that is coupled to a lower surface of the PI substrate layer and protects the PI substrate layer;
a carbon veil sensing layer that is coupled to a lower surface of the cover layer and has the electrical resistance changing due to the expansion/contraction; and
a silicon case that surrounds the stacked thin film constantan sensing layer, PI substrate layer, cover layer, and carbon veil sensing layer,
in which the PI substrate layer includes:
a first deformation part that has a straight portion and an arc portion having uniform thicknesses that alternately extend to form a serpentine structure;
a second deformation part that is arranged parallel to the first deformation part with a predetermined gap therebetween and forms a mirror-symmetrical structure with the first deformation part;
a first connecting part that has one end of the first deformation part and one end of the second deformation part connected thereto and is formed with a fastening joint; and
a second coupling part that has the other end of the first deformation part and the other end of the second deformation part connected thereto and is formed with the fastening joint,
the thin film constantan sensing layer includes:
a first constantan sensing unit that is connected to an upper surface of the first deformation part and has the straight portion and the arc portion having different thicknesses that alternately extend to form the serpentine structure;
a second constantan sensing unit that is coupled to an upper surface of the second deformation part and is connected to the first constantan sensing unit to form a mirror-symmetrical structure with the first constantan sensing unit; and
a pair of constantan electrode units that is coupled to an upper surface of the first coupling part and has one end of the first constantan sensing unit and one end of the second constantan sensing unit, respectively, connected thereto, and
the carbon veil sensing layer includes:
a carbon veil sensing unit that is connected to the first constantan sensing unit and the second constantan sensing unit and expands/contracts together with the first constantan sensing unit and the second constantan sensing unit; and
a pair of carbon veil electrode units that is connected to the upper surface of the first coupling part and connected to the carbon veil sensing unit.

According to an aspect of the present disclosure, the thin film constantan sensing layer made of constantan which maintains the electrical resistivity in the constant temperature range and has good fatigue life and thus maintains the stable performance for a long time, and the carbon veil sensing layer with good tensile strength and tensile elastic modulus measure the electrical resistance variations, thereby detecting the expansion/contraction. The thin film constantan sensing layer exhibits the linear resistance variations during the expansion/contraction, and therefore, has high accuracy. However, since the thin film constantan sensing layer is thin, when the thin film constantan sensing layer expands by 50 to 60%, there is a risk that the thin film constantan sensing layer breaks. On the other hand, the carbon veil sensing layer has the low response linearity, but has the measured displacement larger than the thin film constantan sensing layer. Therefore, the thin film constantan sensing layer and the carbon veil sensing layer may operate complementarily to improve the sensor performance.

According to an aspect of the present disclosure, the PI substrate layer and the thin film constantan sensing layer coupled thereon are formed in the serpentine structure, thereby facilitating the expansion/contraction, so the expansion/contraction can be performed well. On the other hand, unlike the PI substrate layer formed with uniform thicknesses, by making the position and thickness of the thin film constantan sensing layer, whose electrical resistance changes due to the expansion/contraction, different from each other, it is possible to increase the sensitivity of the resistance variation, but unlike the existing constantan material sensor that only detects the expansion, it is possible to simultaneously detect the expansion and contraction with a single sensor.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram illustrating an expansion/contraction carbon veil constantan sensor according to an exemplary embodiment of the present disclosure;

FIG. 2A is an enlarged view of portion A-1 illustrated in FIG. 1, and FIG. 2B is an enlarged view of portion A-2 illustrated in FIG. 1;

FIG. 3 is a cross-sectional view taken along the line B-B illustrated in FIGS. 2A and 2B;

FIG. 4 is a diagram illustrating a PI substrate layer constituting the expansion/contraction carbon veil constantan sensor according to an exemplary embodiment of the present disclosure;

FIG. 5 is a diagram illustrating a thin film constantan sensing layer constituting the expansion/contraction carbon veil constantan sensor according to an exemplary embodiment of the present disclosure;

FIG. 6 is a diagram illustrating a carbon veil sensing layer constituting the expansion/contraction carbon veil constantan sensor according to an exemplary embodiment of the present disclosure;

FIG. 7 is a diagram illustrating a state in which the expansion/contraction carbon veil constantan sensor according to an exemplary embodiment of the present disclosure is connected to a resistance measuring device;

FIG. 8 is a diagram illustrating an equivalent circuit of a thin film constantan sensing layer resistance; and

FIG. 9 is a graph comparing displacement-resistance linearity of the thin film constantan sensing layer and the carbon veil sensing layer.

### DETAILED DESCRIPTION OF THE EMBODIMENT

Hereinafter, an expansion/contraction carbon veil constantan sensor according to an exemplary embodiment of the present disclosure will be described in detail.

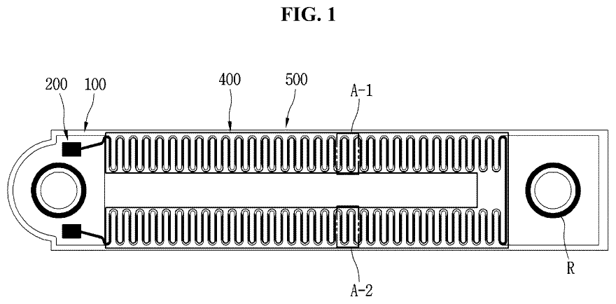

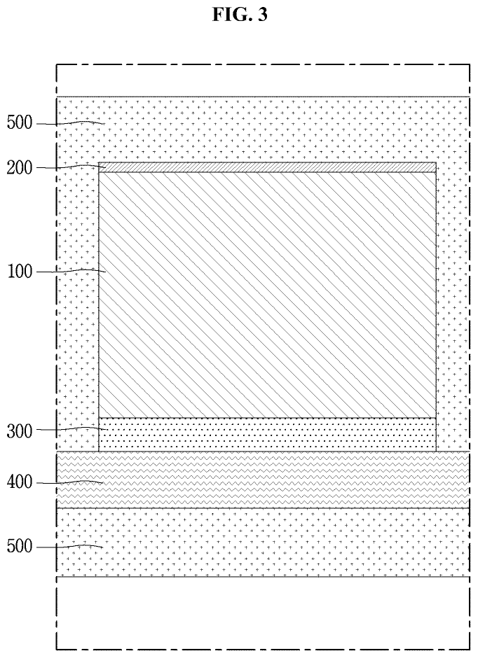

As illustrated in FIGS. 1 to 3, an expansion/contraction carbon veil constantan sensor according to an exemplary embodiment of the present disclosure is composed of a PI substrate layer 100, a thin film constantan sensing layer 200, a cover layer 300, a carbon veil sensing layer 400, and a silicon case 500.

### [PI Substrate Layer 100]

The PI substrate layer 100 is made of polyimide and has flexibility and insulation. The PI substrate layer 100 supports the thin film constantan sensing layer 200 coupled to an upper surface to maintain its shape, and blocks a current flowing in the thin film constantan sensing layer 200. In the present exemplary embodiment, the PI substrate layer 100 is formed to a height of 300 to 500 μm.

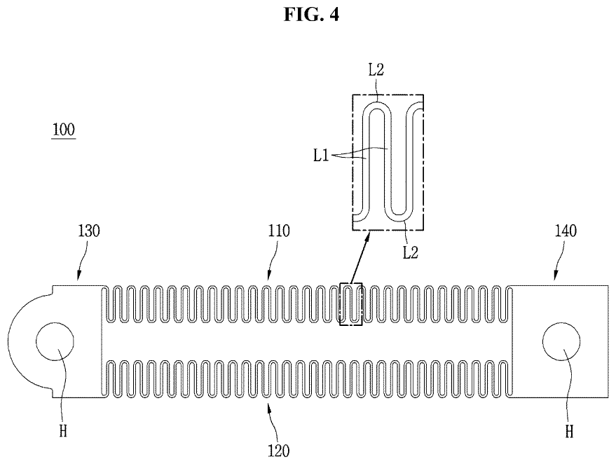

As illustrated in FIG. 4, the PI substrate layer 100 includes a first deformation part 110, a second deformation part 120, a first coupling part 130, and a second coupling part 140.

### First Deformation Part 110, Second Deformation Part 120

The first deformation part 110 has a straight portion L1 and an arc portion L2 having uniform thicknesses that alternately extend to form a serpentine structure. It is preferable that the straight portions L1 of the first deformation part 110 is formed to have a shape that is parallel to each other before deformation. A thickness of the first deformation part 110 is formed to a minimum critical value that can be manufactured.

The second deformation part 120 is arranged side by side with a predetermined gap from the first deformation part 110 and forms a mirror-symmetrical structure with the first deformation part 110. That is, the second deformation part 120 is basically formed in the same shape as the first deformation part 110.

Since the second deformation part 120 is formed in the mirror-symmetrical structure with the first deformation part 110, the inner direction arc portion L2 of the first deformation part 110 and the inner direction arc portion L2 of the second deformation part 120 face each other, and the outer direction arc portion L2 of the first deformation part 110 and the outer direction arc portion L2 of the second deformation part 120 face each other. Due to this structure, the first deformation part 110 and the second deformation part 120 may be deformed equally during expansion/contraction.

### First Coupling Part 130, Second Coupling Part 140

The first coupling part 130 has one end of the first deformation part 110 and one end of the second deformation part 120 connected thereto, with the first deformation part 110 and the second deformation part 120 being arranged parallel to each other, and is formed with a fastening joint H.

The second coupling part 140 has the other end of the first deformation part 110 and the other end of the second deformation part 120 connected thereto, with the first deformation part 110 and the second deformation part 120 being arranged parallel to each other, and is formed with the fastening joint H.

In order to easily distinguish the first coupling part 130 where a constantan electrode unit 230 of the thin film constantan sensing layer 200 is positioned, from the second coupling part 140, it is preferable to form the shapes of the first coupling part 130 and the second coupling part 140 differently. In the present exemplary embodiment, an end portion of the first coupling part 130 is formed with a semicircular shape, and the second coupling part 140 is formed with a rectangular shape.

When installing the expansion/contraction carbon veil constantan sensor on a detection target such as a hydrogen tank, the first coupling part 130 and the second coupling part 140 are attached using an adhesive, or are attached to a protrusion via the fastening joint H or by a bolt fastening method.

### [Thin Film Constantan Sensing Layer 200]

The thin film constantan sensing layer 200 is coupled to an upper surface of the PI substrate layer 100 and has an electrical resistance changing due to the expansion/contraction. The constantan is an alloy of 55% copper and 45% nickel, and has the characteristics of maintaining electrical resistivity in a predetermined temperature range, having a good fatigue life, and thus maintaining stable performance for a long time. The thin film constantan sensing layer 200 made of constantan is thinly coupled to the upper surface of the PI substrate layer 100 in a thin film form.

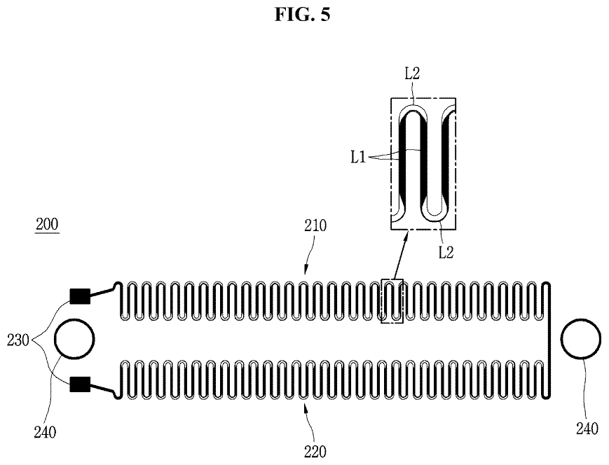

As illustrated in FIG. 5, the thin film constantan sensing layer 200 includes a first constantan sensing unit 210, a second constantan sensing unit 220, a constantan electrode unit 230, and a fastener reinforcing part 240.

### First Constantan Sensing Unit 210

The first constantan sensing unit 210 is connected to an upper surface of the first deformation part 110 and has the straight portion L1 and the arc portion L2 having different thicknesses that alternately extend to form the serpentine structure. In the present exemplary embodiment, a height of the first constantan sensing unit 210 is formed to be 10 to 50 μm.

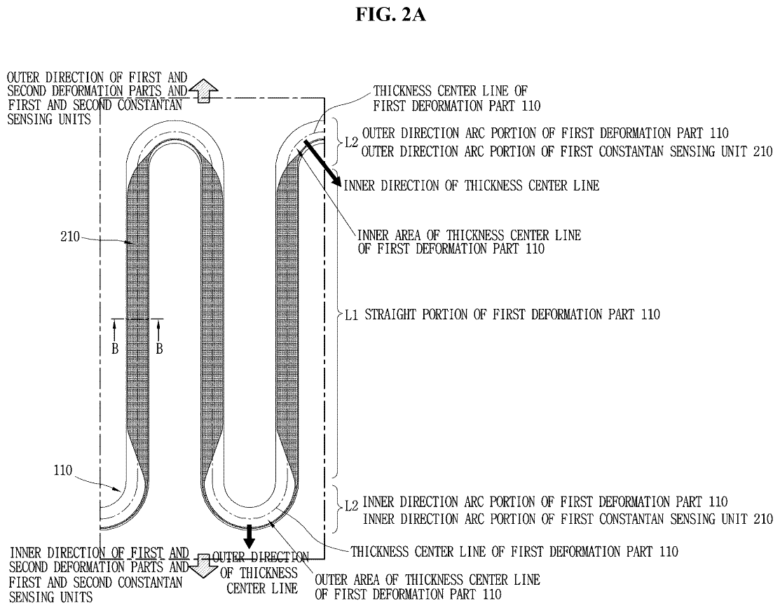

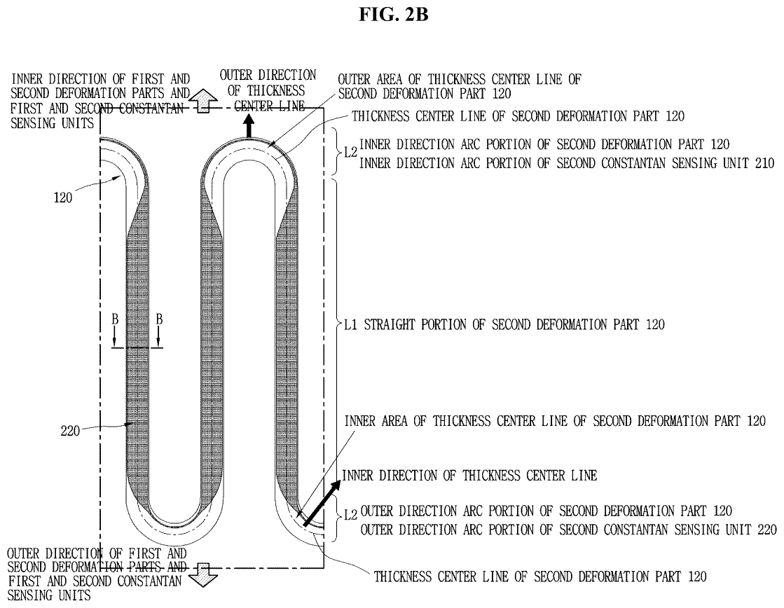

As illustrated in FIG. 2A, the thickness of the arc portion L2 of the first constantan sensing unit 210 is formed to be thinner than the thickness of the straight portion L1. Preferably, the thickness of the straight portion L1 of the first constantan sensing unit 210 is formed to be equivalent to the thickness of the first deformation part 110 or greater than half the thickness of the first deformation part 110, and the thickness of the arc portion L2 of the first constantan sensing unit 210 is formed to be smaller than half the thickness of the straight portion L1 of the first constantan sensing unit 210. When the first constantan sensing unit 210 is coupled to the upper surface at the same thickness as the first deformation part 110, the first constantan sensing unit 210 is well supported by the first deformation part 110 and the risk of breakage is reduced, but the resistance variation due to the expansion/contraction is reduced due to the large thickness. Therefore, only the straight portion L1 of the first constantan sensing unit 210, which is hardly deformed during the expansion/contraction, is made thicker than the arc portion L2 to prevent it from breaking.

Meanwhile, as illustrated in FIG. 2A, the outer direction arc portion L2 of the first constantan sensing unit 210 is positioned in an inner area (near an inner edge of the arc portion 12 of the first deformation part 110) of the thickness center line of the first deformation part 110.

The inner direction arc portion L2 of the first constantan sensing unit 210 is positioned in an outer area (near an outer edge of the arc portion L2 of the first deformation part 110) of the thickness center line of the first deformation part 110. The reason will be described while describing the operation of the expansion/contraction carbon veil constantan sensor.

### Second Constantan Sensing Unit 220

The second constantan sensing unit 220 is coupled to the upper surface of the second deformation part 120, and is connected to the first constantan sensing unit 210 to form the same structure as the first constantan sensing unit 210.

The second constantan sensing unit 220 also forms a mirror-symmetrical structure with the first constantan sensing unit 210 at a predetermined gap, just like the second deformation part 120 that forms the mirror-symmetrical structure with the first deformation part 110. That is, the second constantan sensing unit 220 is basically formed in the same shape as the first constantan sensing unit 210 and is arranged parallel to the first constantan sensing unit 210 at a predetermined gap.

Since the second constantan sensing unit 220 is formed in the mirror-symmetrical structure with the first constantan sensing unit 210, as illustrated in FIG. 2A and FIG. 2B, the inner direction arc portion L2 of the first constantan sensing unit 210 and the inner direction arc portion L2 of the second constantan sensing unit 220 face each other, and the outer direction arc portion L2 of the first constantan sensing unit 210 and the outer direction arc portion L2 of the second constantan sensing unit 220 face each other. Due to this structure, the first constantan sensing unit 210 and the second constantan sensing unit 220 may be deformed equally during the expansion/contraction.

### Constantan Electrode Unit 230

A pair of constantan electrode units 230 is coupled to the upper surface of the first coupling part 130, and one end of the first constantan sensing unit 210 and one end of the second constantan sensing unit 220 are respectively connected thereto. The pair of constantan electrode units 230 is connected to (+) and (−) poles of the resistance measuring device, respectively.

### Fastener Reinforcing Part 240

The fastener reinforcing part 240 has a ring shape and is positioned on outer circumferential surfaces of each fastening joint H of the first coupling part 130 and the second coupling part 140. The fastener reinforcing part 240 contains copper in the constantan, so soldering reinforcement is possible. Therefore, when installing the expansion/contraction carbon veil constantan sensor in hydrogen vessel and using a protrusion or bolt fastening, soldering reinforcement may be added to prevent the fastening joint H from being torn or cut.

### [Cover Layer 300]

The cover layer 300 is coupled to a lower surface of the PI substrate layer 100. The cover layer 300 is formed in the same shape and size as the PI substrate layer 100 to support the thin film constantan sensing layer 200 and the PI substrate layer 100. The cover layer 300 is made of a flexible plastic material.

The thin film constantan sensing layer 200, the PI substrate layer 100, and the cover layer 300 are stacked to form one layer, and this layer is manufactured using a flexible printed circuit board (FPCB) manufacturing method. That is, the PI substrate layer 100 material is stacked on the cover layer 300 material, and the pattern of the thin film constantan sensing layer 200 is formed on the upper surface of the PI substrate layer 100 material through an exposure process and an etching process, and then the PI substrate layer 100 is made by being cut in a shape using a laser.

### [Carbon Veil Sensing Layer 400]

The carbon veil sensing layer 400 is coupled to a lower surface of the cover layer 300, and the electric resistance changes due to the expansion/contraction. The carbon veil sensing layer 400 is bonded to the lower surface of the layer composed of the thin film constantan sensing layer 200, the PI substrate layer 100, and the cover layer 300 by an adhesive to form a separate layer. The carbon veil sensing layer 400 complements the thin film constantan sensing layer 200 to detect the expansion/contraction, while the carbon veil sensing layer 400 is coupled to the lower surface of the thin film constantan sensing layer 200 together with the PI substrate layer 100 and the cover layer 300 to function as a structure that supports the thin film constantan sensing layer 200.

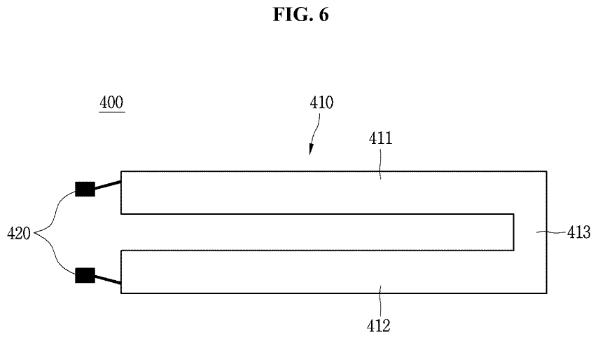

As illustrated in FIG. 6, the carbon veil sensing layer 400 includes a carbon veil sensing unit 410 and a carbon veil electrode unit 420.

### Carbon Veil Sensing Unit 410

The carbon veil sensing unit 410 is made of carbon veil and expands/contracts together with the first constantan sensing unit 210 and the second constantan sensing unit 220.

The carbon veil is a mat-shaped carbon fiber that is thinly spread out, and carbon fibers of a predetermined length are randomly arranged to create a path through which current flows. The carbon veil has high tensile strength and tensile elastic modulus, and the resistance characteristics change depending on the content and direction of the carbon fiber.

The density of the carbon fiber changes due to the deformation of the carbon veil, which changes the resistance. When the thickness of the carbon veil is thickened, the resistance variation may be greatly increased, but the measurement error increases due to the pressure from other materials disposed on the carbon veil. Therefore, it is preferable to make the carbon veil thin, but when the thin carbon veil is made into a serpentine structure like the PI substrate layer 100, it is easy to break when an external force is applied. Therefore, the carbon veil sensing unit 410 does not form a serpentine structure but uses the carbon veil in the form of a mat with a uniform width and length.

The carbon veil sensing unit 410 is formed in the shape of ‘C’ letter. The carbon veil sensing unit 410 is composed of a first region 411 formed in a uniform width and length corresponding to at least the entire width and length of the first deformation part 110, a second region 412 formed in a uniform width and length corresponding to at least the entire width and length of the second deformation part 120, and a third region 413 connecting the first region 411 and the second region 412.

### Carbon Veil Electrode Unit 420

A pair of carbon veil electrode units 420 is coupled to the upper surface of the first coupling part 130 and connected to one end of the first region 411 of the carbon veil sensing unit 410 and one end of the second region 412 of the carbon veil sensing unit 410, respectively. The pair of carbon veil electrode units 420 is connected to the (+) and (−) poles of the resistance measuring device, respectively.

### [Silicon Case 500]

The silicon case 500 surrounds and insulates and protects the stacked thin film constantan sensing layer 200, PI substrate layer 100, cover layer 300, and carbon veil sensing layer 400. The silicon case 500 is manufactured to have a length of 60 mm and a width of 20 mm.

Hereinafter, the operation of the expansion/contraction carbon veil constantan sensor according to an exemplary embodiment of the present disclosure will be described in detail.

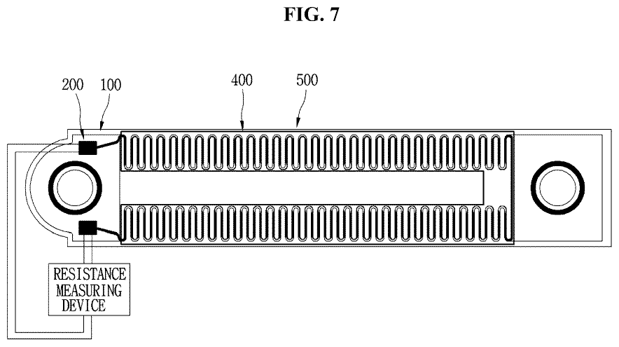

As illustrated in FIG. 7, the constantan electrode unit 230 of the thin film constantan sensing layer 200 is connected to the resistance measuring device, and separately, the carbon veil electrode unit 420 of the carbon veil sensing layer 400 is connected to the resistance measuring device, so that the change in electric resistance of the thin film constantan sensing layer 200 and the change in electric resistance of the carbon veil sensing layer 400 are measured, respectively.

### [Detection by Thin Film Constantan Sensing Layer 200]

The expansion/contraction is primarily detected by the electrical resistance variations of the thin film constantan sensing layer 200.

### Expansion

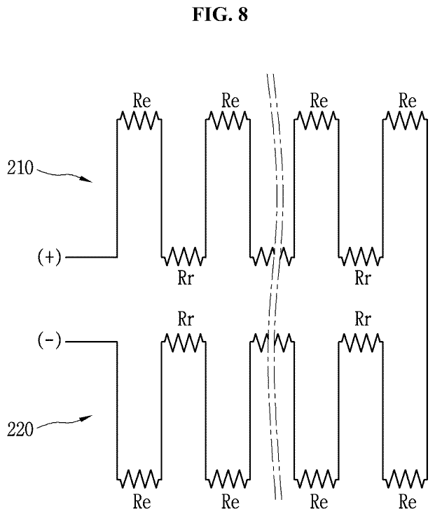

Refer to FIGS. 2 and 8.

During the expansion, the inner area of the arc portion L2 of the first deformation part 110 expands and the outer area of the arc portion L2 of the first deformation part 110 contracts, based on the thickness center line of the first deformation part 110.

In this case, when comparing the resistance variation of the arc portion L2 of the first constantan sensing unit 210, a resistance variation Re when the outer direction arc portion L2 of the first constantan sensing unit 210 is positioned in the inner area of the thickness center line of the first deformation part 110 is greater than a resistance variation Rr when the inner direction arc portion L2 of the first constantan sensing unit 210 is positioned in the outer area of the thickness center line of the first deformation part 110 (Re>Rr).

Therefore, during the expansion, the expansion is detected by the resistance variation Re of the outer direction arc portion L2 of the first constantan sensing unit 210 positioned in the inner area of the thickness center line of the first deformation part 110. The second constantan sensing unit 220 also detects the expansion using the same principle.

### Contraction

Refer to FIGS. 2 and 8.

During the contraction, the outer area of the arc portion L2 of the first deformation part 110 expands and the inner area of the arc portion L2 of the first deformation part 110 contracts, based on the thickness center line of the first deformation part 110.

In this case, when comparing the resistance variation of the arc portion L2 of the first constantan sensing unit 210, the resistance variation Rr when the inner direction arc portion L2 of the first constantan sensing unit 210 is positioned in the outer area of the thickness center line of the first deformation part 110 is greater than the resistance variation Re when the outer direction arc portion L2 of the first constantan sensing unit 210 is positioned in the inner area of the thickness center line of the first deformation part 110 (Re<Rr).

Therefore, during the contraction, the contraction is detected by the resistance variation Rr of the inner direction arc portion L2 of the first constantan sensing unit 210 positioned in the outer area of the thickness center line of the first deformation part 110. The second constantan sensing unit 220 also detects the contraction using the same principle.

### [Detection by Carbon Veil Sensing Layer 400]

The secondary expansion/contraction is detected by complementing the thin film constantan sensing layer 200 by the electrical resistance variations of the carbon veil sensing layer 400.

During the expansion, the carbon fiber density of the carbon veil of the carbon veil sensing unit 410 decreases, and thus, the electrical resistance increases.

During the contraction, the carbon fiber density of the carbon veil of the sensing layer increases, and thus, the electrical resistance decreases.

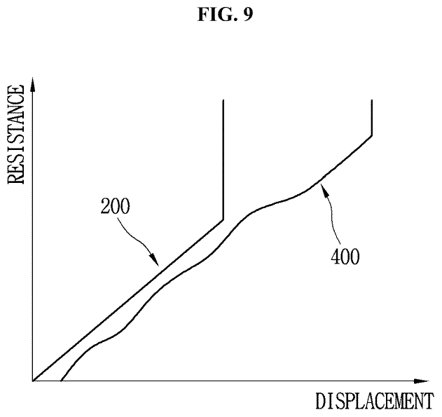

As illustrated in FIG. 9, the thin film constantan sensing layer 200 linearly exhibits the linear resistance variations during the expansion/contraction, so the accuracy is higher. However, since the thin film constantan sensing layer 200 is thin, when the thin film constantan sensing layer 200 expands by 50 to 60%, there is a risk that the thin film constantan sensing layer 200 breaks. On the other hand, the carbon veil sensing layer 400 has the low response linearity, but the measured displacement is larger than that of the thin film constantan sensing layer 200. Therefore, the thin film constantan sensing layer 200 and the carbon veil sensing layer 400 may work complementarily to improve the performance of the sensor.

1. An expansion/contraction carbon veil constantan sensor, comprising:
a flexible and insulating PI substrate layer;
a thin film constantan sensing layer that is coupled to an upper surface of the PI substrate layer and has an electrical resistance changing due to expansion/contraction;
a cover layer that is coupled to a lower surface of the PI substrate layer and protects the PI substrate layer;
a carbon veil sensing layer that is coupled to a lower surface of the cover layer and has the electrical resistance changing due to the expansion/contraction; and
a silicon case that surrounds the stacked thin film constantan sensing layer, PI substrate layer, cover layer, and carbon veil sensing layer,
wherein the PI substrate layer includes:
a first deformation part that has a straight portion and an arc portion having uniform thicknesses that alternately extend to form a serpentine structure;
a second deformation part that is arranged parallel to the first deformation part with a predetermined gap therebetween and forms a mirror-symmetrical structure with the first deformation part;
a first connecting part that has one end of the first deformation part and one end of the second deformation part connected thereto and formed with a fastening joint; and
a second coupling part that has the other end of the first deformation part and the other end of the second deformation part connected thereto and is formed with the fastening joint,
the thin film constantan sensing layer includes:
a first constantan sensing unit that is connected to an upper surface of the first deformation part and has the straight portion and the arc portion having different thicknesses that alternately extend to form the serpentine structure;
a second constantan sensing unit that is coupled to an upper surface of the second deformation part and is connected to the first constantan sensing unit to form a mirror-symmetrical structure with the first constantan sensing unit; and
a pair of constantan electrode units that is coupled to an upper surface of the first coupling part and has one end of the first constantan sensing unit and one end of the second constantan sensing unit, respectively, connected thereto, and
the carbon veil sensing layer includes:
a carbon veil sensing unit that is connected to the first constantan sensing unit and the second constantan sensing unit and expands/contracts together with the first constantan sensing unit and the second constantan sensing unit; and
a pair of carbon veil electrode units that is connected to the upper surface of the first coupling part and connected to the carbon veil sensing unit.

2. The expansion/contraction carbon veil constantan sensor of claim 1, wherein the thickness of the arc portion of the first constantan sensing unit is formed to be thinner than that of the straight portion of the first constantan sensing unit, and
the thickness of the arc portion of the second constantan sensing unit is formed to be thinner than that of the straight portion of the second constantan sensing unit.

3. The expansion/contraction carbon veil constantan sensor of claim 1, wherein the first constantan sensing unit is positioned along a thickness center line of the first deformation part,
an outer direction arc portion of the first constantan sensing unit corresponding to an outer direction arc portion of the first deformation part is positioned in an inner area of the thickness center line of the first deformation part, and
an inner direction arc portion of the first constantan sensing unit corresponding to an inner direction arc portion of the first deformation part is positioned in an outer area of the thickness center line of the first deformation part.

4. The expansion/contraction carbon veil constantan sensor of claim 1, wherein the second constantan sensing unit is positioned along a thickness center line of the second deformation part,
an outer direction arc portion of the second constantan sensing unit corresponding to an outer direction arc portion of the second deformation part is positioned in an inner area of the thickness center line of the second deformation part, and
an inner direction arc portion of the second constantan sensing unit corresponding to an inner direction arc portion of the second deformation part is positioned in an outer area of the thickness center line of the second deformation part.

5. The expansion/contraction carbon veil constantan sensor of claim 1, wherein the thin film constantan sensing layer further includes a ring-shaped fastener reinforcing part positioned on outer circumferential sides of each fastening joint of the first coupling part and the second coupling part.

6. The expansion/contraction carbon veil constantan sensor of claim 1, wherein the carbon veil sensing unit includes:
a first region that is formed with a uniform width and length corresponding to at least an entire width and length of the first deformation part;
a second region that is formed with a uniform width and length corresponding to at least an entire width and length of the second deformation part; and
a third region that connects the first region and the second region.
